(19) United States
(12) Patent Application Publication
(10) Pub. No.: US 2005/0108363 A1
(43) Pub. Date: May 19, 2005

(54) Web page update notification method and web page update notification device

(76) Inventors: Shin Torigoe, Osaka (JP); Takashi Nishi, Osaka (JP)

Correspondence Address: RABIN & Berdo, PC, 1101 14TH STREET, NW, SUITE 500, WASHINGTON, DC, 20005, US

(21) Appl. No.: 10/720,690

(22) Filed: Nov. 25, 2003

(30) Foreign Application Priority Data
Nov. 25, 2002 (JP) 341009/2002

(51) Int. Cl. G06F 15/16

(52) U.S. Cl. 709/218

(57) ABSTRACT

In order to provide an update notification device and method, which can output update notifications from which whether information meaningful to a user on a Web page was updated or not can be easily determined, the invention is an update notification device and method for repeatedly accessing at least one Web site identifiable with a preset address and outputting a notification message including the presence or absence of the update to the outside if any web page has been updated in the Web site. In this case, updated data is extracted from the updated Web page, and, in outputting, one or both of the title of the updated data and the updated data and the address of the Web page are added to the notification message.

### BACKGROUND OF THE INVENTION

1. Field of the Invention

The present invention relates to an update notification method and device for notifying that a Web page open to the public on a network has been updated.

2. Description of the Related Art

Recently, many Web sites are open to public with the wide spread of Internet. Various kinds of information are open to the public from the business to personal Web sites.

The Web page updates of these Web sites are irregular because the updates depend on the convenience of the Web managers. Therefore, users cannot recognize the updates immediately without accessing the Web pages frequently. However, even though users access Web pages in order to check the updates, information on many Web pages often remains old. Then, these accesses become wasteful.

JP-A-2002-73455 discloses a conventional device for checking Web pages by using an agent server in advance and notifying the title and Uniform Resource Locator (URL) of an updated Web page thereof to users by e-mail. An example of the e-mail sent to users is shown in the reference numeral M1 in FIG. 4. With the device, a user can access the Web page of the Web site the update of which was notified by e-mail so that wasteful accesses can be prevented.

However, according to the conventional technology, notified information is only information specifying an updated Web page (specific information such as a URL). Thus, information on how the Web page was updated is not provided. Therefore, the user needs to actually access the Web site or Web page and to check whether information meaningful to the user was updated or not.

### SUMMARY OF THE INVENTION

The invention was made in view of these problems, and it is an object of the invention to provide an update notification device and method, which can provide update notifications from which whether information meaningful to a user on a Web page has been updated or not can be easily determined. The invention is an update notification device and method for repeatedly accessing at least one Web site identifiable with a preset address and outputting a notification message including the presence of the update to the outside if any web page has been updated in the Web site. In this case, updated data is extracted from the updated Web page, and, in outputting, one or both of the header of the updated data and the updated data and the address of the Web page are added to the notification message.

### BRIEF DESCRIPTION OF THE DRAWINGS

FIG. 1 is a block diagram showing a first embodiment of the invention and shows the entire network construction including an update notification device;

FIG. 2 is a flowchart showing processing steps of update notification in the update notification device shown in FIG. 1;

FIG. 3 is an explanatory diagram showing a method for obtaining differential information in the processing steps shown in FIG. 2;

FIG. 4 is a diagram illustrating the comparison between a conventional notification mail M1 and a mail magazine M2 according to the invention as an example of a notification message sent from the update notification device to a user terminal;

FIG. 5 is a block diagram showing a second embodiment of the invention and shows an entire network construction including an update notification device;

FIG. 6 is a flowchart showing processing steps of update notification in the update notification device shown in FIG. 5;

FIG. 7 is a diagram showing template and mail examples used in the construction shown in FIG. 5;

FIG. 8 is a block diagram showing a third embodiment of the invention and shows an entire network construction including an update notification device;

FIG. 9 is a flowchart showing processing steps of update notification in the update notification device shown in FIG. 8; and

FIG. 10 is a diagram showing a mail example as a notification message output in the construction shown in FIG. 8.

### DESCRIPTION OF THE PREFERRED EMBODIMENTS

Embodiments of the invention will be described in detail with reference to appended drawings.

### First Embodiment

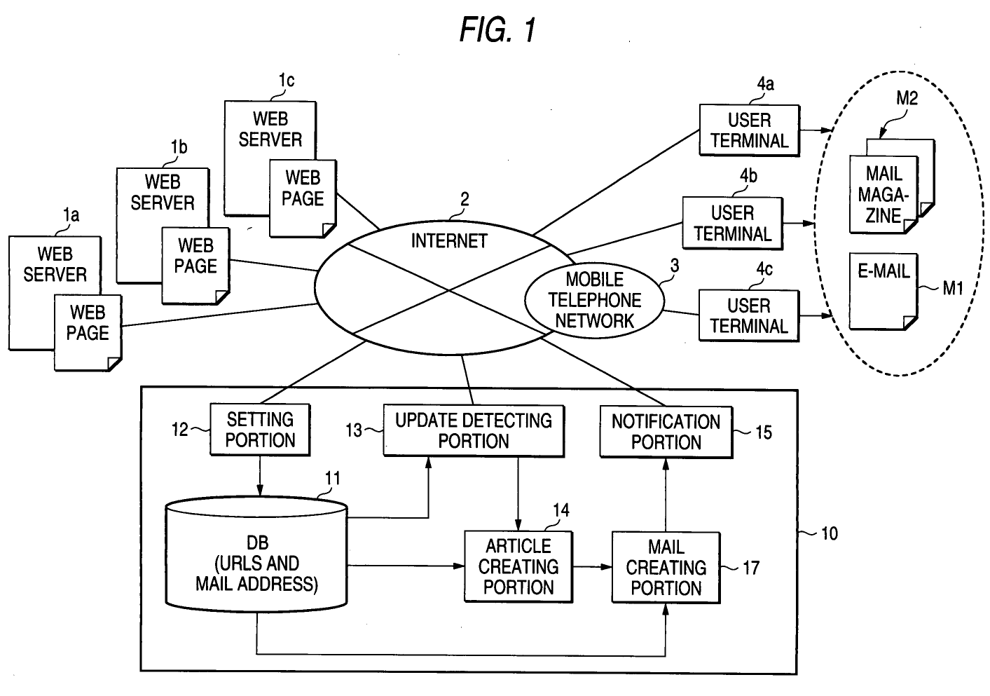

FIG. 1 shows a construction of an update notification device 10 according to a first embodiment of the invention. The update notification device 10 is connected to multiple Web servers 1a to 1c and multiple user terminals 4a to 4c through Internet 2 and/or a mobile telephone network 3. Each of the Web servers 1a to 1c is a server computer establishes a Web site on Internet 2 and provides at least one Web page under the site address to many computer terminals (not shown) including the user terminals 4a to 4c connected to Internet 2. A Web page is an information document generally also called homepage and provided on Internet and is a document mainly written in Hyper Text Markup Language (HTML). In general, a Web page is regularly or irregularly updated by a Webmaster operating each of the Web servers 1a to 1c or a Web site or Web page manager.

Each of the user terminals 4a to 4c is a terminal such as a computer and a mobile telephone used by a user to which update notifications will be provided by the update notification device 10. Each of the update notifications is supplied in form of the mail magazine M2 or e-mail M1 illustrated in dashed lines.

In the description of this embodiment, three Web servers 1a to 1c and three user terminals 4a to 4c are shown in the construction of this embodiment. However, those numbers are not limited thereto, and the construction of the update notification device 10 according to the invention can accommodate many Web servers and many user terminals.

The update notification device 10 may be a general server computer and includes a setting portion 12, an update detecting portion 13, a notification portion 15, an article creating portion 14, a mail creating portion 17 and a database (also called DB hereinafter) 11.

Once an URL, which is a network address of one of the Web servers 1a to 1c to be detected with respect to whether the Web site or Web page has been updated or not, is input through the communication with each of the user terminals 4a to 4c, the setting portion 12 stores the URL in the DB 11.

The update detecting portion 13 accesses, at predetermined intervals, for example, the Web page distributed by one of the Web servers 1a to 1c corresponding to the URL stored in the DB 11 and detects a difference from the state at the previous access. In order to perform this detection, the update detecting portion 13 can hold the Web page at the previous access for detecting the difference and compare the data between the Web page at the previous access and the Web page at the latest access. If there is any difference, the update detecting portion 13 can extract the difference as an updated part.

The article creating portion 14 creates an article title and body included in a notification message in accordance with the content of the updated part extracted by the update detecting portion 13. The article title and body are created for each update on a Web page of one Web site, for example.

The mail creating portion 17 creates one notification message regarding one to multiple articles created by the article creating portion 14.

A notification message is basically created for each of the user terminals 4a to 4c to be notified and includes information notifying the update in the Web server (one or more of the Web servers 1a to 1c) corresponding to the URLs specified by the user terminals 4a to 4c through the setting portion 12.

Alternatively, the notification message may have a form of mail magazine to be sent to multiple user terminals (such as the user terminals 4a to 4c) instead of being created exclusively for one user terminal (such as the user terminal 4a).

The notification portion 15 sends one or multiple notification messages created by the mail creating portion 17 to each of the corresponding user terminals 4a to 4c through Internet 2 or the mobile telephone network 3.

The database 11 stores URLs of Web sites or Web pages to be detected with respect to the presence of the updates and mail addresses of users. The URL to be stored may be the top page address of the Web site or may be the address of a specific Web page under the Web site.

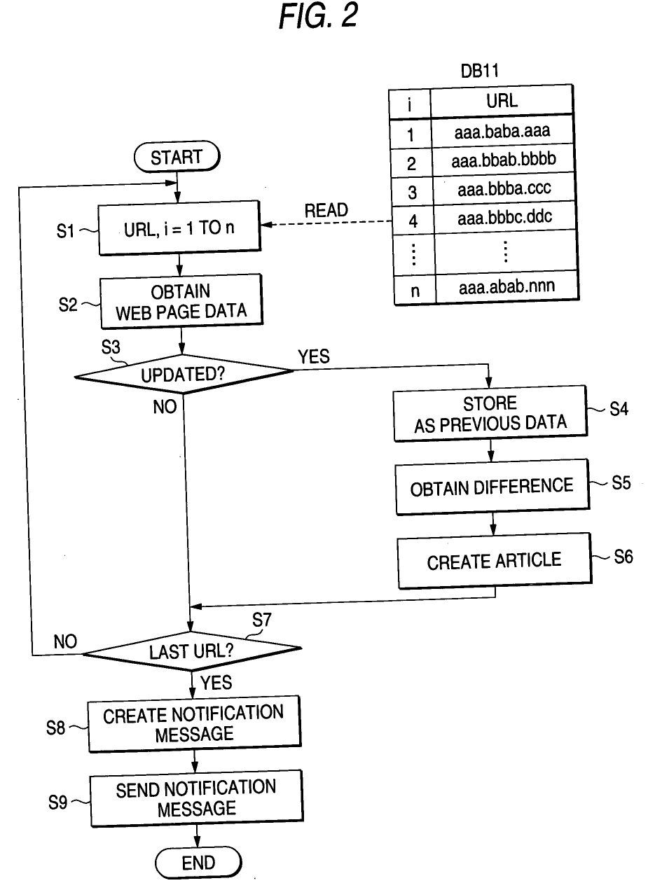

FIG. 2 shows processing steps of an update notification in the update notification device 10 shown in FIG. 1.

First of all, the update notification device 10 causes the update detecting portion 13 to read multiple URLs set in the DB 11 and starts a loop in the range of i=1 to n (where n is an positive integer giving the number of set URLs) (step S1).

Next, one of the URLs is accessed, and the Web page data (called latest data hereinafter) is newly obtained (step S2). Here, if the Web page holds a frame, each page data within the frame is obtained.

Next, the latest data is compared with Web page data at the previous access (called previous data hereinafter). If updated, the processing goes to a step S4, which will be described later. If not, the processing goes to a step S7, which will be described later (step S3).

Next, the obtained latest data is stored as new previous data to be used for the next comparison (step S4).

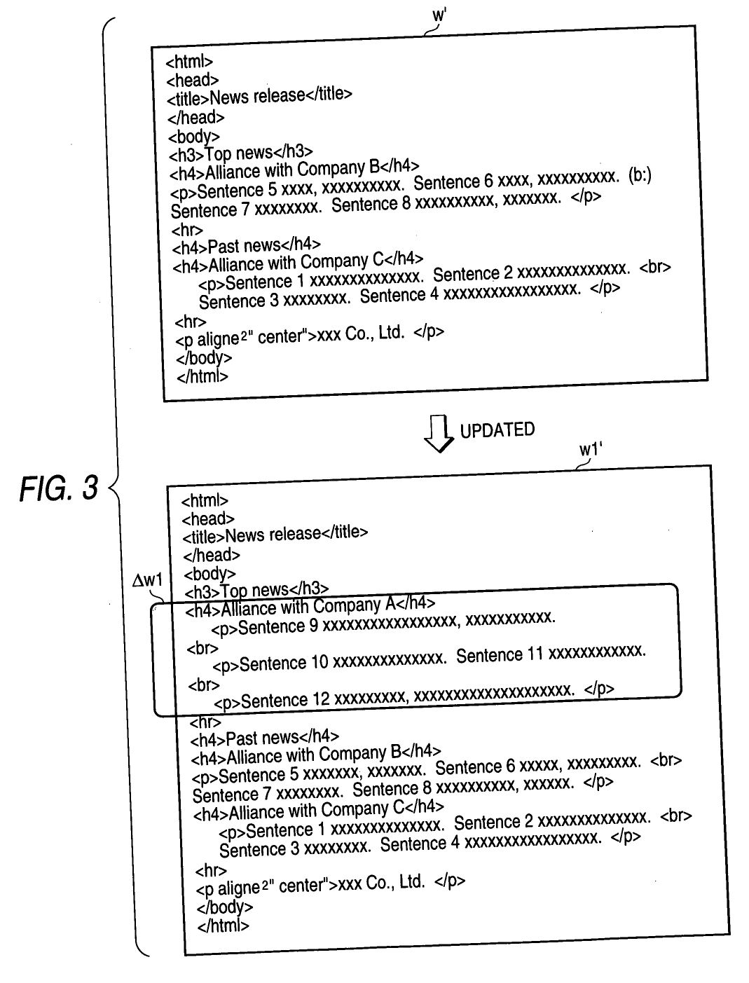

Next, in the article creating portion 14, the update notification device 10 obtains a difference (that is, differential information piece) between the previous data and latest data (step S5). The differential information piece can be obtained by repeatedly storing every line of the previous data and the latest data as an array component and comparing every array components of the previous data with all of the array components of the latest data for (all the array components of the precious date) (see FIG. 3).

Next, the update notification device 10 uses the extracted difference to create an article in the article creating portion 14 (step S6). In the creation of the article, the page title, for example, may be used as the article title while an increase in differential information may be used as an article body. Furthermore, the title may be created from the difference, and an article may have a structure only having the title or body.

Next, in the update detecting portion 13, the update notification device 10 determines whether a given URL is the last one or not. If there are more URLs to be processed, the processing goes to the step S1 where the next URL is processed. If no URLs to be processed are left, the processing goes to a step S8 (step S7).

Next, in the mail creating portion 17, the update notification device 10 combines one or more articles created at the step S6 and creates the body of a notification message (step S8). At this step, the notification message body may be created only by combining multiple articles. However, more desirably, symbols and/or strings corresponding to ruled lines may be inserted for more easy-to-read construction.

Next, in the notification portion 15, the up date notification device 10 sends the created notification message by e-mail to one of user terminals having the setting of the URLs, that is, one of the user terminals 4a to 4c (step S9). Instead of sending e-mail, the notification message may be printed, sent by fax, stored into a storage medium or output in a viewable Web form. In this case, the mail address of each user stored in the DB 11 may be replaced by data corresponding to the output form (such as a facsimile number in the fax case).

When there are multiple users, the processing at the steps S1 to S9 is repeated the number of times equal to the number of users.

FIG. 3 specifically describes a method for obtaining differential information through the processing steps shown in FIG. 2.

In FIG. 3, Web pages W1 and W1′ are shown in text form written in HTML tags. Here, the Web page W1 is updated to the Web page W1′. In this case, by obtaining the difference at the step S5 shown in FIG. 2, differential information ΔW1 is obtained. In the example in FIG. 3, the differential information ΔW1 is the newly added part, “Alliance with Company A. (Return) Sentence 9 XXXXXXXXXXXXXXXXXXXXXXXXXXXX. (Return) Sentence 10 XXXXXXXXXXXXXXXXXXXXXXXXXXXX. (Return) Sentence 11 XXXXXXXXXXXXXXXXXXXXXXXXXXXX. (Return) Sentence 12 XXXXXXX, XXXXXXXXXXXXXXXXXXXX.”

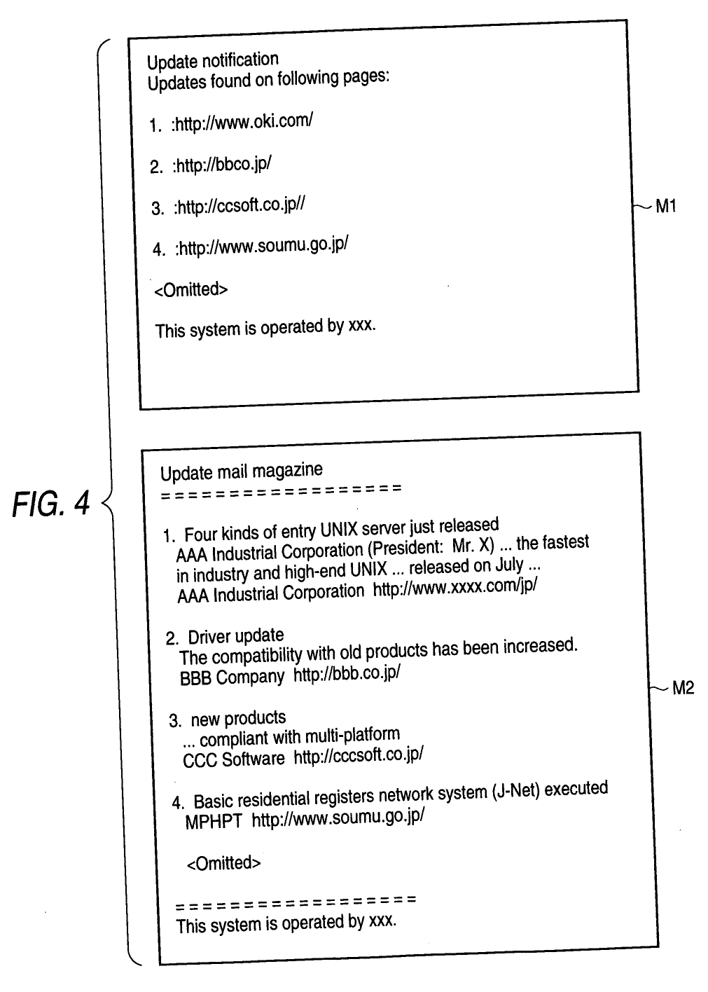

FIG. 4 shows examples of a created notification message. The mail magazine M2 is an example of the mail magazine for notifying the address of an updated Web site and the contents of the update.

As described above, according to the first embodiment, a specified URL is accessed, and a difference from the state at the previous access is used in order to create the update notification message. Thus, the receiver of the notification message can recognize the changed article and the outline without detail reference to the URL having updates. As a result, the URL only needs to be accessed in order to obtain more detail information. The operator issuing notification messages as mail magazines upon updates in a given Web site can reduce the cost and issue well-timed information.

### Second Embodiment

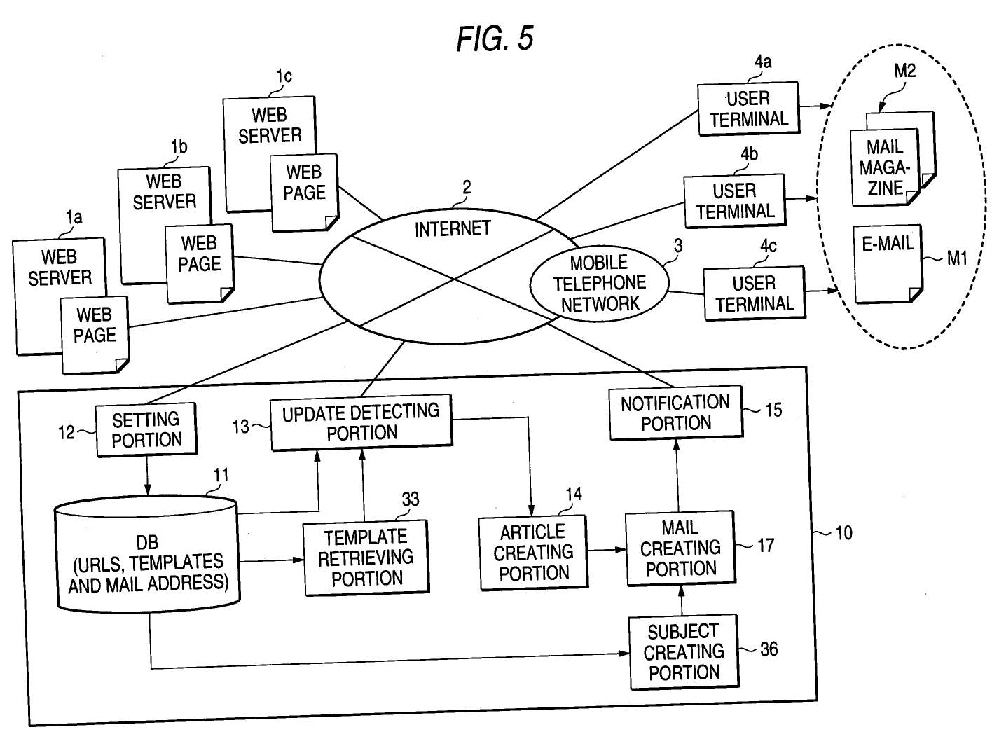

FIG. 5 shows a construction of an update notification device 10 according to a second embodiment of the invention. In the second embodiment, multiple Web servers 1a to 1c connected to the update notification device 10, multiple user terminals 4a to 4c, Internet 2 and a mobile telephone network 3 have the same constructions as those of the first embodiment. Therefore, the description of those constructions will be omitted here.

The update notification device 10 may be a general server computer like the first embodiment and includes a setting portion 12, an update detecting portion 13, a notification portion 15, an article creating portion 14, a mail creating portion 17 and a DB 11. The update notification device 10 according to this embodiment further includes a template retrieving portion 33 and a subject creating portion 36. The template retrieving portion 33 retrieves a Web page template from the DB 11 and supplies the template to the update detecting portion 13 or the article creating portion 14. The subject creating portion 36 creates a subject, that is a mail title, for a mail notification message created in the mail creating portion 17.

The article creating portion 14 creates articles like the first embodiment and further creates the articles in accordance with article templates. The mail creating portion 17 creates mails like the first embodiment and further adds titles to the mails in accordance with the contents of the subjects supplied from the subject creating portion 36.

The DB 11 stores the URL of the Web site or Web page to be detected with respect to whether the Web site or Web page was updated or not and the e-mail addresses of users. The DB 11 further stores the template of the Web site or Web page.

The template of each Web page may be set in advance by a manager of the update notification device 10 or may be set together with the corresponding URL by the setting portion 12. In this case, the mail address of each user, which is stored in the DB 11, may be replaced by data in accordance with the output form. When multiple users exist, the steps S51 to S62 are repeated.

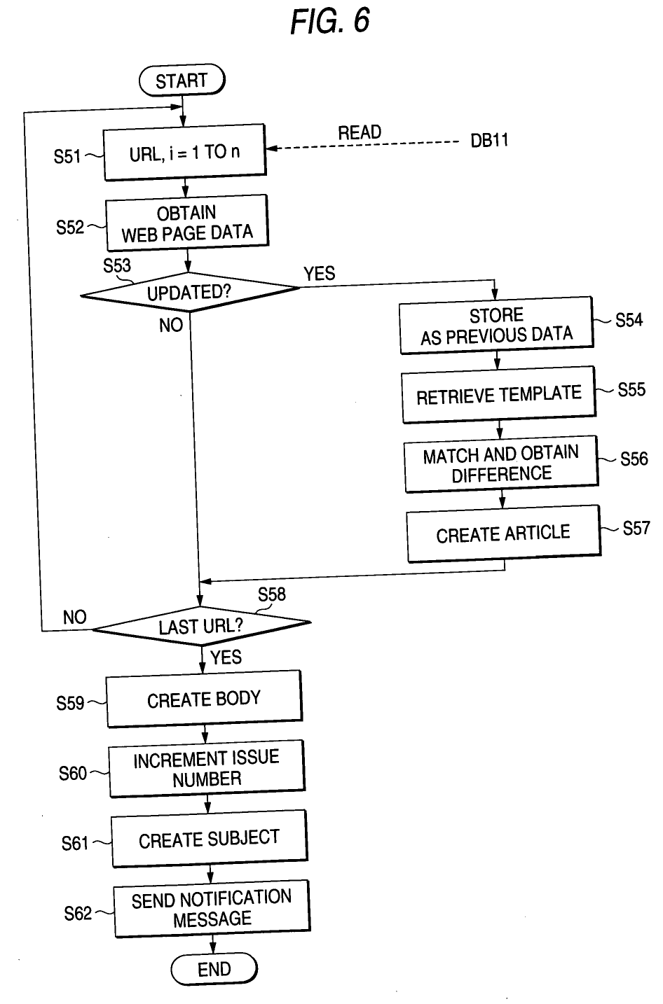

FIG. 6 shows processing steps for update notification in the update notification device 10 shown in FIG. 5. In the update detecting portion 13, the update notification device 10 reads multiple URLs from the DB 11 and starts a loop in the range of i=1 to n (where n is a positive integer giving the number of set URLs) (step S51).

Next, each of the URLs is accessed, and the Web page data, that is, the latest data is newly obtained (step S52).

Then, the latest data is compared with the previous data. If the data has been updated, the processing goes to a step S54, which will be described later. If not the processing goes to a step S58, which will be described later (step S53).

The update detecting portion 13 stores the obtained latest data as the new previous data to be used for the next comparison (step S54).

In the article creating portion 14, the update notification device 10 uses the template retrieving portion 33 to obtain the Web template corresponding to the URL from the DB 11 (step S55).

Next, the Web template and the updated Web page data are matched and/or the difference therebetween is obtained (step S56).

The article creating portion 14 creates an article by using the data extracted from the matching (step S57). According to the second embodiment, the entire updated page is matched with the template. However, after the matching with the template, the differences in matched parts may be obtained.

Next, the update notification device 10 determines whether the given URL is the last one or not. If any unprocessed URL is left, the processing goes to the step S51 where the next URL is processed. If no unprocessed URLs are left, the processing goes to a step S59 (step S58).

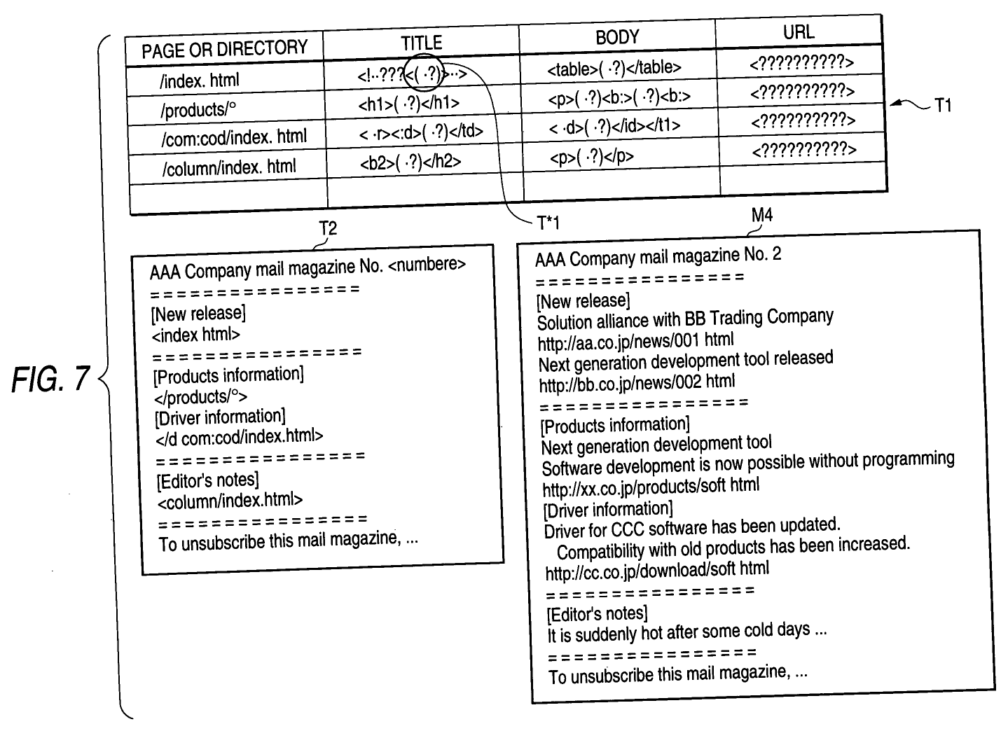

Next, in the mail creating portion 17, one or more articles created at the step S57 are connected in accordance with a notification message template and, the body of the notification message is created (step S59). Here, the template of the body of the notification message can include the updated data corresponding to multiple URLs (see template T2 in FIG. 7). Desirably, the parts without updates under the URLs within the template are omitted.

Next, the update notification device 10 increments the issue number of the created notification message (step S60). The incremented issue number is stored in the DB 11.

Then, in the subject creating portion 36, the title or subject is created, and the issue number is given to the body of the notification message in accordance with the template (step S61).

Next, in the notification portion 15, the update notification device 10 sends the created notification message by e-mail to any one of the user terminals having the setting of the URLs, that is, to any one of the user terminals 4a to 4c (step S62). Instead of sending e-mail, the notification message may be printed, sent by fax, stored into a storage medium or output in a viewable Web form.

FIG. 7 shows examples of the template and notification message in the construction shown in FIG. 5. The template T2 is an example of the template of the body of a notification message. The template T1 is an example of the template of an article. Here, as a function of the templates, the part determining the frame of an arbitrary string is written as “(.+?)” like the one in the shown example (see T11 in FIG. 7). The notification message M4 is an example of a created notification message.

As described above, according to the second embodiment, a specified URL is accessed, and the Web page is matched with the Web page template set in accordance with the URL. Thus, the notification message can be created. According to the first embodiment, an indefinite number of URLs are the targets while the target URLs are limited according to the second embodiment. Thus, the proper template corresponding to the target URLs can be used. As a result, by using the template, a highly readable notification message can be created.

### Third Embodiment

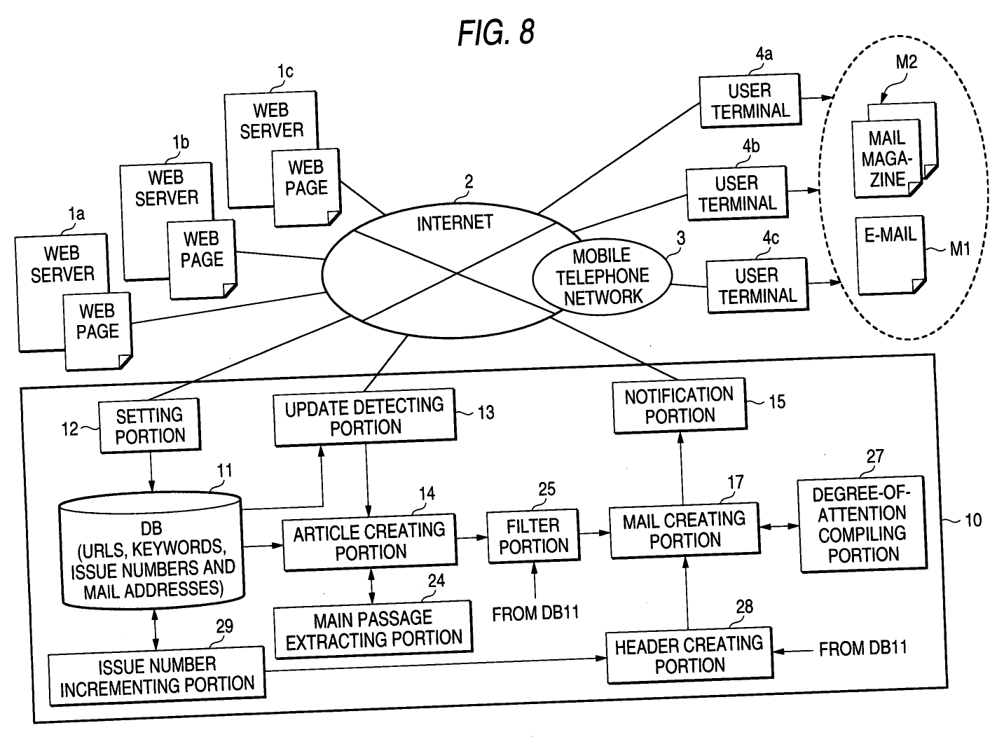

FIG. 8 shows a construction of an update notification device 10 according to a third embodiment of the invention. In the third embodiment, multiple Web servers 1a to 1c connected to the update notification device 10, multiple user terminals 4a to 4c, Internet 2 and a mobile telephone network 3 have the same constructions as those of the first embodiment. Therefore, the description of those constructions will be omitted here.

The update notification device 10 may be a general server computer like the first embodiment and includes a setting portion 12, an update detecting portion 13, a notification portion 15, an article creating portion 14, a mail creating portion 17 and a DB 11. The update notification device 10 according to this embodiment further includes a main passage extracting portion 24, a filter portion 25, a degree-of-attention compiling portion 27, a header creating portion 28, and an issue number incrementing portion 29. The main passage extracting portion 24 extracts a main passage from differential information when differential information is equal to or more than a predetermined threshold value (such as 100 letters or ten lines). The filter portion 25 removes articles without a keyword set in the DB 11. The degree-of-attention compiling portion 27 compiles articles gathering attentions from users. The header creating portion 28 creates the mail header of a notification message. The issue number incrementing portion 29 increments the notification message issue number for each user.

The DB 11 stores the URL of the Web site or Web page to be detected with respect to whether the Web site or Web page has been updated or not. The DB 11 includes at least one or more keywords corresponding to each user, mail addresses of users, and notification message (mail magazine) issue numbers.

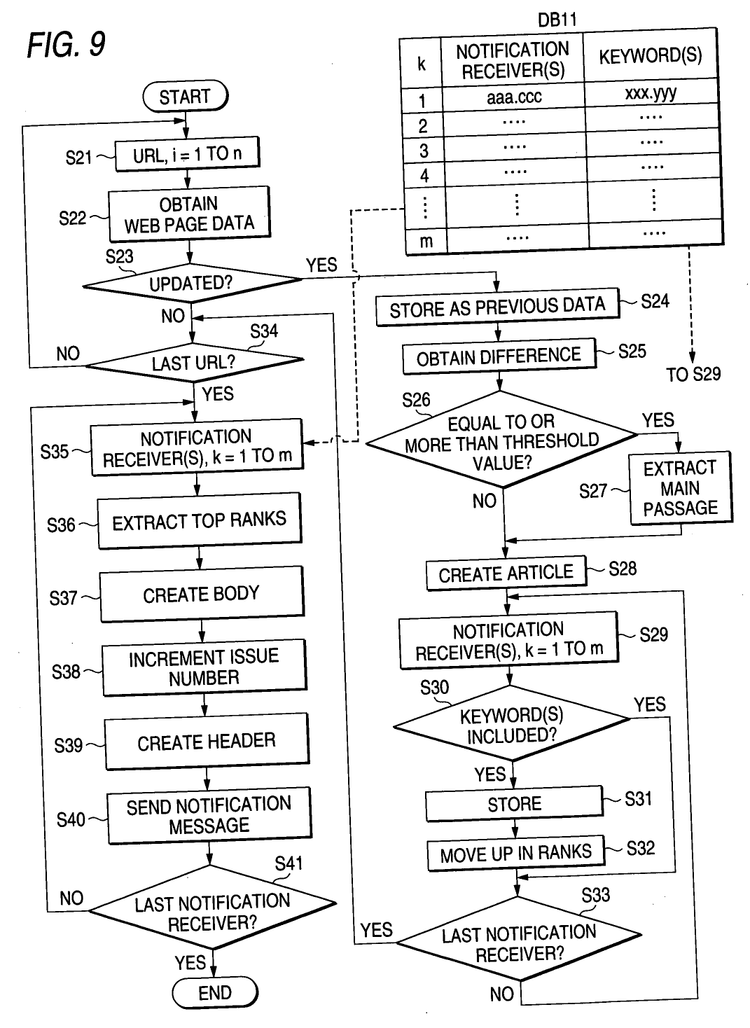

FIG. 9 shows processing steps of update notification in the update notification device 10 shown in FIG. 8. First of all, in the update detecting portion 13, the update notification device 10 reads multiple URLs from the DB 11 and starts a loop in the range of i=1 to n (where n is a positive integer giving the number of set URLS) (step S21).

Next, each of the URLs is accessed, and the Web page data, that is, the latest data is newly obtained (step S22).

Then, the latest data is compared with the previous data. If the Web page data has been updated, the processing goes to a step S24, which will be described later. If not, the processing goes to a step S34, which will be described later (step S23).

The update detecting portion 13 stores the obtained latest data as the new previous data to be used for the next comparison (step S24).

In the article creating portion 14, the update notification device 10 obtains a difference between the previous data and the latest data (step S25).

If the differential value is equal to or more than the threshold value, the processing goes to a step S27. If the differential value is less than the threshold value, the processing goes to a step S28 (step S26).

Next, in the main passage extracting portion 24, main passage extracting processing is performed on the differential data, and data in a size less than the threshold value is obtained (step S27).

By using the extracted main passage, the article creating portion 14 creates an article (step S28). In the article creation, the page title, for example, may be used as the article title, and an increase in differential information may be used as the article body. Also, the title may be created from the differential data while the notification message may have only the title or the body.

Next, in the degree-of-attention compiling portion 27, the update notification device 10 starts a loop with the number of notification receiver's mail addresses of users desiring update notifications with respect to the URL. In other words, the update notification device 10 reads multiple mail addresses from the DB 11 and starts a loop in the rage of k=1 to m (where m is a positive integer giving the number of mail addresses) (step S29).

Next, when a user desiring update notifications sets a keyword and if the keyword is not included in articles, the processing goes to a step S33, which will be described later. If the keyword is included in the articles, the processing goes to a step S31 (step S30).

Then, articles are stored for each of notification receivers (step S31).

In this case, the rank of article distribution is increased by one in the degree-of-attention compiling portion 27 (step S32).

Then, it is determined whether a given notification receiver is the last one or not. If the given user desiring the update notification is the end of the loop, the processing goes to a step S34, which will be described later. If not, the processing goes to the step S29 where the processing is performed for the next user desiring the update notification (step S33).

Then, it is determined whether a given URL is the last one or not. If any unprocessed URL is left, the processing goes to the step S21 where the next URL is processed. If no unprocessed URLs are left, the processing goes to a step S35, which will be described later (step S34).

Next, the update notification device 10 performs processing for each user desiring a given update notification. That is, the update notification device 10 reads multiple mail addresses from the DB 11 and starts a loop in the range of k=1 to m (where m is a positive integer giving the number of mail addresses) (step S35).

The top ten cases, for example, in the articles ranked in the degree-of-attention compiling portion 27 are extracted (step S36).

Next, in the mail creating portion 17, the remaining articles are connected with the top ten cases at the beginning, and the body of the notification message is created (step S37).

At these steps S36 and S37, all of the articles may be sorted and be connected in ranking order. Furthermore, in order to create the body of a notification message, multiple articles may be only connected. However, symbols and/or strings corresponding to ruled lines are desirably inserted so as to provide an easy-to-read construction to the users.

Next, in the issue number incrementing portion 29, the update notification device 10 increments an issue number for each user desiring the update notification (step S38).

Next, in the header creating portion 28, the header is created by giving a subject having the issue number and mail addresses of the notification receivers to the body of the created notification message (step S39). The subject may be a fixed string, a time stamp or the article title(s) or body arbitrarily or randomly extracted from the article(s). The issue number does not have to be included in the subject but may be included in the body.

Next, in the notification portion 15, the update notification device 10 sends the created notification message to the mail addresses of the users desiring the update notification in accordance with the header of the notification message (step S40).

Then, it is determined whether a us er desiring the update notification, which is being processed, is the last user or not. If so, the processing ends. If not, the processing goes to the step S35 where the processing is continuously performed on the next user (step S41).

Instead of sending a notification message by e-mail at the step S40, the notification message may be printed, sent by fax, stored into a storage medium or output in a viewable Web form. In this case, the mail address of each user stored in the DB 11 may be replaced by data corresponding to the output form (such as a facsimile number in the fax case).

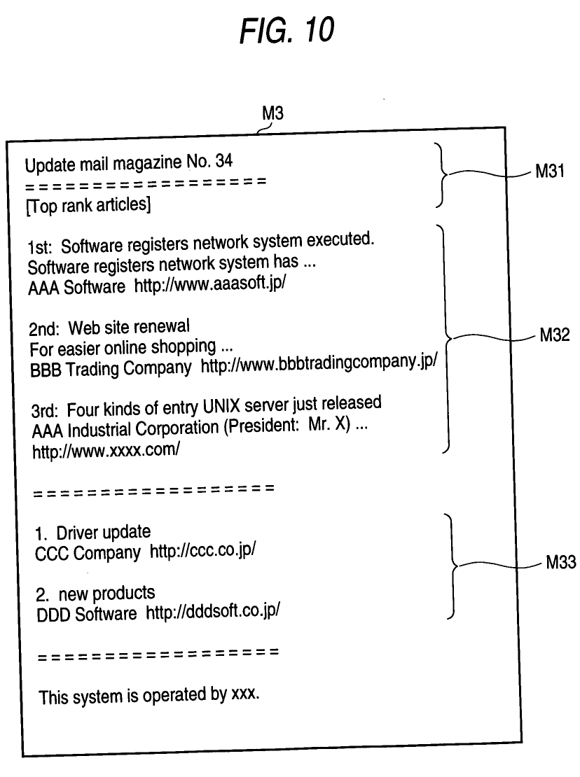

FIG. 10 shows an example of a created mail magazine M3. Here, the mail magazine M3 includes multiple blocks M31, M32 and M33. An incrementing issue number is shown in the block M31. The rank is shown in the block M32. The other updated articles are shown in the block M33.

As described above, according to the third embodiment, an URL and keyword needing the update of which needs to be notified are specified for each user. Thus, each user can receive notification messages having the updated data on demands of the user. In the mail magazine, the updated data are converted to the main part so that the user can understand the updates easily. Furthermore, information regarding the articles gathering attentions from the other users can be provided as ranking information, which may bring the mail magazine nearer to perfection.

An update notification device according to the invention may be combined with or applied to a system connected to Internet or an intranet and can be used for operating an update notification service site. The components of the invention may be realized in software or hardware construction.

As described above, according to an update notification device and method of the invention, not only the presence of updates on a given Web page is output, but also the updated data or the main passage may be added to the notification message to be output to the user. Therefore, the user can easily determine whether or not a given registered Web page has been updated, which is meaningful to the user.

1. An update notification device for repeatedly accessing at least one Web site identifiable with a preset address and outputting a notification message including the presence or absence of the update to the outside if any web page has been updated in the Web site, the device comprising:
updated data extracting means for extracting updated data from the updated Web page; and
updated data output means for, in outputting, adding to the notification message one or both of the header of the updated data and the updated data and the address of the Web page.

2. An update notification device according to claim 1, wherein the updated data extracting means extracts the updated data from the differential information piece in character or line between the previous data and latest data of the Web page.

3. An update notification device according to claim 2, wherein the updated data extracting means has means for converting the updated data to a main passage when the size of the differential information piece is equal to or more than a predetermined threshold value.

4. An update notification device according to claim 1, wherein the updated data extracting means extracts the updated data from a differential information piece of a part determined by a template held in advance in accordance with the Web page.

5. An update notification device according to claim 4, wherein the updated data extracting means has means for converting the updated data to a main passage when the size of the differential information piece is equal to or more than a predetermined threshold value.

6. An update notification device according to claim 1, further comprising:
notification-receiver's address holding means for holding the address of a user terminal for receiving an update notification with respect to each of the at least one Web site,
wherein the updated data output means sends a notification message having the updated data to the address of the user terminal with respect to each of the at least one Web site.

7. An update notification device according to claim 6, wherein the notification-receiver's address holding means further has means for holding at least one keyword with respect to the address of the user terminal, wherein the updated data extracting means has means for removing the differential information piece from the updated data when the differential information piece does not include the held keyword.

8. An update notification device according to claim 6, wherein the notification-receiver's address holding means further has means for holding at least one keyword with respect to the address of the user terminal,
wherein the updated data extracting means has means for compiling the rank, which indicates the degree-of-attention of the Web page, in accordance with the frequency of occurrence of updated data having a keyword corresponding to each of the entire user terminals.

9. An update notification device accord ing to claim 1, wherein the updated data output means has means for creating the notification message in accordance with a predetermined template before the output of the notification message.

10. An update notification device according to claim 1, wherein the updated data output means has means for creating the title of the notification message from the updated data.

11. An update notification device according to claim 10, wherein the updated data output means has means for giving, to the title of the notification message, a notification message issue number incremented for each output or each of the notification-receivers' addresses.

12. An update notification method for repeatedly accessing at least one Web site identifiable with a preset address and outputting a notification message including the presence or absence of the update to the outside if any web page has been updated in the Web site, the method comprising:
an updated data extracting step for extracting updated data from the updated Web page; and
an updated data output step for, in outputting, adding to the notification message one or both of the header of the updated data and the updated data and the address of the Web page.

13. An update notification method according to claim 12, wherein the updated data extracting step extracts the updated data from the differential information piece in character or line between the previous data and latest data of the Web page.

14. An update notification method according to claim 13, wherein the updated data extracting step has a step for converting the updated data to a main passage when the size of the differential information piece is equal to or more than a predetermined threshold value.

15. An update notification method according to claim 12, wherein the updated data extracting step extracts the updated data from a differential information piece of a part determined by a template held in advance in accordance with the Web page.

16. An update notification method according to claim 15, wherein the updated data extracting step has a step for converting the updated data to a main passage when the size of the differential information piece is equal to or more than a predetermined threshold value.

17. An update notification method according to claim 12, further comprising:
a notification-receiver's address holding step for holding the address of a user terminal for receiving an update notification with respect to each of the at least one Web site,
wherein the updated data output step sends a notification message having the updated data to the address of the user terminal with respect to each of the at least one Web site.

18. An update notification method according to claim 17, wherein the notification-receiver's address holding step further has a step for holding at least one keyword with respect to the address of the user terminal, wherein the updated data extracting step has a step for removing the differential information piece from the updated data when the differential information piece does not include the held keyword.

19. An update notification method according to claim 17, wherein the notification-receiver's address holding step further has a step for holding at least one keyword with respect to the address of the user terminal,
wherein the updated data extracting step has a step for compiling the rank, which indicates the degree-of-attention of the Web page, in accordance with the frequency of occurrence of updated data having a keyword corresponding to each of the entire user terminals.

20. An update notification method according to claim 12, wherein the updated data output step has a step for creating the notification message in accordance with a predetermined template before the output of the notification message.

21. An update notification method according to claim 12, wherein the updated data output step has a step for creating the title of the notification message from the updated data.

22. An update notification method according to claim 21, wherein the updated data output step has a step for giving, to the title of the notification message, a notification message issue number incremented for each output or each of the notification-receivers' addresses.
